(19) United States
(12) Patent Application Publication
(10) Pub. No.: US 2017/0139053 A1
(43) Pub. Date: May 18, 2017

(54) SIMULTANEOUS SIGNAL RECEPTION DEVICE OF DIFFERENT SATELLITE NAVIGATION SYSTEMS

(71) Applicant: Open Joint Stock Company Research and Development Center "Electronic Information Computation Systems, Moscow (RU)

(72) Inventors: Daniil VISHIN, Voronezh (RU); Ivan GRES, Voronezh (RU); Yaroslav PETRICHKOVICH, Moscow (RU); Pavel RUDNEV, Voronezh (RU); Vasiliy SEVERINOV, Voronezhskaya (RU); Tatiana SOLOKHINA, Moscow (RU)

(21) Appl. No.: 15/352,294

(22) Filed: Nov. 15, 2016

(30) Foreign Application Priority Data
Nov. 16, 2015 (RU) 2015148995

(51) Int. Cl. G01S 19/33; G01S 19/32

(52) U.S. Cl. CPC G01S 19/33; G01S 19/32

(57) ABSTRACT

The present invention is related to the area of receiving and processing of signals of the satellite navigation systems. The technical result of the present invention is creation of a device for simultaneous signal receiving of different satellite navigation systems with an increased positioning rate in difficult receiving environment, and also with an increased volume and reliability of information on geographical coordinates of the object and with a possibility of use of several navigation satellite systems, such as GLONASS, GPS, Galileo and BeiDou/Compass.

### FIELD OF THE INVENTION

The present invention is related to the area of signal reception and processing of satellite navigation systems, namely, to simultaneous signal reception devices of different satellite navigation systems, and can be applied to the navigators providing routing of vehicles and other mobile objects, and also for accelerated positioning in severe interference environment, frequent loss of satellite navigation signals or repeated signal reflections from various objects.

### DESCRIPTION OF PRIOR ART

Currently there are two orbiting satellite groups allowing implementation of navigation, these are such global positioning systems as GPS (USA) and GLONASS (Russia). The commercial navigation receivers used today assume the use of open codes of one or both mentioned systems in the frequency ranges of L1 and/or L2. In the latter case such receivers are often called the global navigation satellite system receivers (GNSS). Besides, some perspective projects of the European Galileo system, and also Chinese BeiDou (Compass) are actively developed. With a variety of new components, the multistandard multiband receivers using all advantages of visible satellite group of the available systems and ready to reception of new navigation standard signals become more and more affordable and demanded by the mass market.

One of the main problems resolved in the modern navigation receivers is the fast detection and steady receiving of signals providing fast positioning of the user and continuous tracking of the user subsequent relocation. Especially this purpose is actual in severe receiving environment, such as high speed of movement and/or a set of the hindrances breaking direct visibility of satellites and causing fast change of the satellite visible group (for example, dense urban development). The need to track the greatest possible number of satellites of different navigation systems for their operational inclusion into a decision provides creation of multistandard navigation receivers noticeably benefiting in the positioning speed and accuracy against their monostandard analogs. The existing distinctions in signal generation of all navigation standards actual today do not allow using of many famous solutions for GPS-GLONASS receivers. On the other hand, simple increase in the number of channels for satellite signal reception of each new navigation system makes a receiver resource-intensive, that is often unacceptable, in particular, for mobile devices. Thus, the purpose of creation of a high speed, power effective, universal multi-channel receiver which resources can be flexibly adapted to the current situation is urgent. U.S. Pat. No. 6,441,780 “Receiver for pseudo-noise signals from satellite radio-navigation system” dated 27 Aug. 2002 is known from the state of the art. This invention represents multi-channel dual-standard GPS-GLONASS L1 range receiver. The main intention of the known device is to fight against multipath distribution of the signal received from a satellite. For evaluation of the multipath effect and its compensation, in addition to correlative subchannels P (Prompt, exact adjustment of pseudo-random sequence) and EML (differential assessment of time synchronization by means of the Early Minus Late code combination—the advancing and delaying of pseudo-random sequence), an additional correlative subchannel for offset assessment of the pseudo-random sequence strobe of the received signal is introduced into each parallel channel, and the code sequence applied to the EML channel can be added to the corrective symbol sequence. Rather low acquisition rate of satellite signals is related to disadvantages of this device, since the search is carried out by sequential search of all code delays with use of the available set of parallel channels. Besides, such receiver doe not allow to receive signals of BeiDou and Galileo.

RU Patent #2435307 “The device for processing of navigation signals of GLONASS, GPS and Galileo” dated 27 Nov. 2011 also proposes the receiver designed on the basis of Prompt-EML of the channel, but modified for receiving of Galileo. A signal of this navigation system, in addition to the secondary code, uses modulation by a subcarrier sequence, in particular BOC—Binary Offset Carrier which is meander (two-level) modulation. BOC (1,1) means that each symbol of the long range code with a clock rate of 1,023 MHz is modulated by one period of meander rectangular oscillations. An appropriate demodulator is added to the channel for removal of this subcarrier oscillations. However, the said tracking channel does not allow fast search of signals and does not assume extension of the received signals due to receiving of BeiDou (Compass) signals.

The greatest rate of detection, acquisition and tracking of a received signal is provided by the devices using a set of parallel correlators. Thus, the resource intensity remains the main disadvantage of multi-channel devices of this kind. The solution proposed in U.S. Pat. No. 6,208,291 “Highly parallel GPS correlator system and method” dated 27 Mar. 2001 is targeted to reduction of the correlator resource intensity. This solution supposes several parallel reception channels, each performing detection and time synchronization, where all possible signal delays of this satellite (in case of GPS with pseudo-random sequence 1023 counting, in case of 2 counting on the chip it makes K=2046 of positions of a code) are analyzed by K subchannels, and for reduction of overall dimensions the accumulation is made by means of the multiport multiplexer, one adder and the memory unit for storage of all results of accumulation operating at a frequency several times higher than the data handling frequencies in the subchannels. Such structure allows to make time synchronization very quickly, but being optimized for receiving GPS signals only, it does not allow to adjust effectively the frequency offset in the conditions of high object dynamics.

US Patent Application #20070160121 “Signal correlation method and apparatus” dated 12 Jul. 2007 offers an alternative approach to reduction of the hardware resources in case of the multi-channel receiver. According to this invention, in each channel a partial correlation is made for a unit of symbols, X long, and subsequent summing of results of accumulation Y of such units, and X*Y is equal to the pseudo-random sequence length. In the search mode the clock rate in channels can increase several times in respect to the tracking mode for increase of the accuracy, and the partial coherent accumulation in adjacent time slots can be used for assessment of Doppler frequency offset. Despite enhanced accuracy of adjustment in the channels, the search in such device is still run by sequential search of all possible hypotheses by means of the available set of channels that makes the time of search very long. Besides, such receiver does not allow to receive signals of BeiDou and Galileo.

The solution proposed in U.S. Pat. No. 7,061,972 “GPS receiver having dynamic correlator allocation between a memory-enhanced channel for acquisition and standard channels for tracking” dated 13 Jun. 2006 offers the searching channel containing the data memory and a set of parallel correlative channels for tracking of satellite signals. The memory channel allows to write data sampling of arbitrary length into the memory and rapidly to analyze it by the correlator in the channel, and the tracking channels are disabled at this time. After a signal detection, the storage channel is disabled, and the receiving is carried out by the tracking channels. The disadvantage of such architecture means: the correlative core of tracking channels in the acquisition mode is also used for processing of the signal written in the memory, i.e., it is excluded from signal receiving and does not allow simultaneous high speed search and effective tracking/setup of already found satellite signals. Besides, such receiver does not allow receiving of BeiDou and Galileo signals.

The idea of recording a signal sampling and subsequent searching in the written sampling is also considered in U.S. Pat. No. 6,091,785 “Receiver Having a memory based search for fast acquisition of a spread spectrum signal” dated 18 Apr. 2000. The idea of recording a signal sampling and subsequent searching in the written sampling is also considered in U.S. Pat. No. 6,091,785 “Receiver Having a memory based search for fast acquisition of a spread spectrum signal” dated 18 Apr. 2000. The invention supposes non-crossing fast signal detection hardware device and a set of tracking channels. Fast search is executed by record of the received signal replica into the memory and it's comparing with code replicas in all possible combinations of shift delays by frequency and pseudo-random sequence. The number of the code replicas stored in the memory in this case will be equal to the number of possible code shifts that provides the use of a big memory cell replacing the traditional pseudo-random sequence generator and the heterodyne used for compensating of the Doppler frequency shift in this solution. The tracking channels use tracking by means of parallel correlators and E-, P- and L-codes of the pseudo-random sequence. In addition to big resource intensity, this solution is oriented only on receiving of GPS signals that it is also possible to consider a disadvantage of the device provided in the invention description.

RU Patent #2456630 “The satellite navigation glonass/gps/galileo-receiver with the correlators asynchronously controlled by the external processor” dated 20 Jul. 2012, provides a hardware and software system, using the external computer outside of the receiver for execution of some operations necessary for the received signal processing. The external computer may be a specialized device for navigation purposes, and also a desktop computer, notebook, tablet, smartphone or other mobile device.

The hardware units of GLONASS and GPS/Galileo correlators, according to the description, include correlators of two types. The correlator unit of the first type contains one or several arrays of the correlators providing parallel computation of correlations for a group of adjacent positions of possible epoch start of a certain satellite in case of a preset Doppler shift. Correlations are calculated for the preset range of the positions remote from each other by a fixed step. The correlator unit of the second type contains a set of the correlators providing parallel computation of correlations for arbitrary positions and the Doppler shifts of one or several satellites. The correlators in the offered device provide possibility of loading in them the modified samples of a navigation signal (replicas). The size of replicas corresponds to duration of the repeated pseudo random code (epoch), equal to one millisecond of GPS and GLONASS signals and to four milliseconds for Galileo signal.

An obvious disadvantage of such solution, directly specified in the invention description, is solution of the navigation problem in the assumption that dynamics of object on which the receiver is set is not too high, and usable sensitivity is provided only in the static mode, because of use of external software module.

RU Patent #2334357 “Device of search of navigation signals” dated 20 Sep. 2008 the solution with use of three navigation systems is also considered. However, the described multi-channel correlator allows to realize only search of GPS, Galileo and GLONASS systems without tracking.

The most close to the declared invention is the satellite navigation receiver with a fast search device of navigation signals in the conditions of high dynamics of the object described in RU Patent #2341898 dated 20 Dec. 2008. The device block diagram is shown in FIG. 1. The fast search device block diagram is shown in FIG. 2. This receiver is selected as a prototype of the declared invention.

The receiver prototype is related to the signal receivers of the GPS and GLONASS satellite radio navigational systems with open code of the frequency range L1. Its technical advantage includes reduction of the signal search time. The receiver contains an antenna 101, a radio-frequency transformer (RF) 102, N-channel digital correlator 110, a fast search device 103, a time mark signal generator 104 and a calculator where the fast search device 103 contains an input GPS/GLONASS signal multiplexer 201, a digital carrier generator 202, a signal shift register 204, a code register 208, M signal multiplexers 205, M code multiplexers 207, M code adders 206, M-input adder 210, an integrator 211, a complex number module square computation unit 212, second adder 213, RAM 214, RAM address generator 215, a maximum choice unit 216, a threshold device 217, and a synchronizer 209. The fast search device 103 provides signal convolution from the complex signal shift register 204 and code sequence from the code register 208, coherent signal accumulation at an interval of 1 msec in the integrator 211 with the subsequent noncoherent accumulation (the adder 213 and RAM 214) during the time set by the calculator depending on the expected signal-to-noise ratio. The receiver operation is controlled by a microprocessor 106 (CPU) which is using a ROM 107 for program storage, a random access memory (Memory 108) for storage of the intermediate data, and realizing interaction with the remaining units of the receiver by means of the data bus and an exchange block 105. The data interchange with the receiver external devices is carried out by an external interface unit 109.

The prototype device represents the satellite navigation receiver with the fast search device of navigation signals in the conditions of high dynamics of object containing connected in series radio-frequency transformer 102, which input forms the receiver signal input, and N-channel digital correlator 110 connected by the data interchange unit 105 to a calculator containing the central processor (CP) 106 connected by a data interchange bus, the random access memory (RAM) 108, the read-only memory (ROM) 107, and the external interface unit 109, which inputs and outputs form the information inputs and outputs of the receiver, while N-channel digital correlator contains a receiver time line generator 104, and each channel of the digital correlator contains an input GPS/GLONASS multiplexer (MUX) 111, a carrier generator (Car. gen.) 113, a carrier adder 112, a code generator (Code gen.) 115, a code adder 114 and an integrator (Int) 116. In order to reduce the search time in the conditions of high dynamics of object, the fast search device 103 containing the synchronizer 209, the GPS/GLONASS multiplexer input 201, the carrier generator (Car. gen.) 202, a carrier adder 203, one input of which is connected to the radio-frequency transformer output and the second input is connected to the carrier generator output is added, the complex signal shift register 204 which input is connected to the carrier adder output, the code register 208, first group of M-multiplexers 205 each having K inputs, while the j-th input of the i-th multiplexer is connected with (j+(i−1)·K)-th bit of the complex signal shift register, and control inputs of all multiplexers are connected to a synchronizer output 209, second group of M-multiplexers 207, each having K inputs, while the j-th input of the i-th multiplexer is connected with (j+(i−1)·K)-th bit of the code register, and control inputs of all multiplexers are connected to the synchronizer 209 output, M code adders 206, and one input of the i-th input adder is connected to the multiplexer of the i-the output from the first group of multiplexers 205, and the second input of the i-th code adder 206 is connected with the multiplexer of the i-th output from the second group of the multiplexers 207, the first M-input adder 210 which inputs are connected to outputs of the code adders, the integrator 211 which input is connected to the output of the first M-input adder 210, the complex signal module square generator 212 which input is connected to the integrator output, the second adder 213, the storage device (RAM) 214, RAM address generator 215, and one input of the second adder 213 is connected to the output of the complex signal module square generator 212, and the second input is connected to the RAM 214 output, and the RAM 214 input is connected to the serial adder output 213, and the RAM address 214 input is connected to the RAM address generator 215 output, the maximum choice unit 216, one input of which is connected to the RAM 214 output, and the second input is connected to the RAM address generator 215 output, and the threshold device 217 which input is connected to the maximum choice unit 216 output, and the output is connected to the data interchange unit 105 input.

Disadvantages of the prototype are the following. The receiver prototype is intended for acceleration of search of signals of the well-known GPS and GLONASS standards and essentially does not allow to receive signals of new navigation standards, since it has no additional units necessary for this purpose, caused by structure of these signals. Besides, one fast search device, as practice shows, does not give a desirable increase in speed of search as allows to check only one signal frequency offset hypothesis of only one satellite for one iteration. Moreover, one-fold analysis of all uncertainty area is often happens insufficient for exact synchronization and it is necessary to carry out more long analysis of computation on the intervals exceeding one epoch.

### BRIEF SUMMARY OF THE INVENTION

The purpose of the declared invention is creation of the simultaneous signal receiving device of different satellite navigation systems with the increased positioning speed in difficult receiving environment, and also with the increased volume and reliability of the information on geographical coordinates of object and with a possibility of use of several navigation satellite systems: GLONASS, GPS, Galileo and BeiDou/Compass.

The problem is resolved by creation of the device for simultaneous signal receiving of different satellite navigation systems containing a antenna 301, connected to a input of a receiving radio-frequency path 302, connected to a correlative processing unit (CPU) 300, and also a navigation central processor (CP) 303, a random access memory (RAM) 304, a read-only memory (ROM) 306, and a fast Fourier transform unit (FFT) 305 which are interconnected and connected to the correlative processing unit (CPU) 300 via a data bus, and executed with an interaction opportunity with other device units via a exchange unit (UE) 308, included into the correlative processing unit (CPU) 300 which also contains a multi-channel correlator (MCC) with different types of channels comprising Q fast search units (UFS) 800, Z universal tracking channels (UFUC) 600, N direct data reading channels 900, a collector 700, a input interface unit (UII) 400, the exchange unit (UE) 308, a signal simulator (SS) 500, and a time line generator (TLG) 309, while the exchange unit 308 is connected to the fast search units (UFS) 800, to the universal tracking channels (UFUC) 600, to the direct data reading channels 900, to the collector 700, to the input interface unit (UII) 400, to the exchange unit (UE) 308, to the signal simulator (SS) 500 and to the time line generator (TLG) 309, which is connected to the radio-frequency path 302 which is connected to the input interface unit 400 which is connected to the signal simulator 500, while the collector 700 is connected to the universal tracking channels, and the fast search units 800, the universal tracking channels 600, the direct data reading channels 900 and the input interface unit 400 are interconnected, while
the receiving radio-frequency path (RF) 302 containing a demodulator executed with a possibility of separation of the signals containing signals of navigation satellites in a preset range of carrier frequencies;
an external interface unit 307 executed with a possibility of information exchange with the end users;
the input interface unit 400 executed with a possibility of the organization of interaction between the correlative processing unit 300 and the radio-frequency path 302, and also with a possibility of connection of correlative channel inputs to the output of the signal simulator 500 in the self-test mode;
the input interface unit 400 executed with a possibility of signal transmission to the inputs of fast search units 800, the universal tracking channels 600 and direct data reading channels 900 executed with a possibility of processing of these signals according to the given settings of each channel;
in the operating mode the correlative processing unit 300 executed with a possibility of functioning in interaction with the central processor 303, and the central processor 303 executed with a possibility of reading of results of correlative processing by the exchange unit 308 of channels and with a recording capability of the channel control data in the appropriate channel registers;
the time line generator 309 executed with a possibility of formation of the device time scale, epoch signals, duration of intervals between which is equal to duration of an epoch of the satellite navigation system, and also with a possibility of clock signal generation necessary for synchronization of operation of all units and modules of the device.
fast search units 800 executed with verifiability of a signal existence of the navigation satellite in the received radio-frequency signal, with a possibility of determination of the navigation satellite signal time shift concerning the epoch signal, and also with a possibility of determination of the Doppler frequency shift caused by mutual relocation of the satellite and the device, while the fast search units 800 are executed with a possibility of detection of existence and position concerning epoch signals, sequence of the checked signals in the signals selected by the demodulator at least for two epochs;
each fast search unit 800 containing the received signal hypothesis generator which is presented as machine-readable data which provide sequence formation of the checked signals corresponding to the signal sequence of the navigation satellites set according to the settings transmitted from the central processor 303 via the exchange unit 308;
each fast search unit 800 connected to the bus of data, addresses and control of the device that provides transmission of a checked hypothesis together with the position data to one of the universal tracking channels 600, and also continuous determination and setup of provision of a hypothesis concerning an epoch signal, and thus optimum separation of the received signal, besides the fast search unit 800 is executed with a possibility of request and/or installation via the data, address and control bus a new hypothesis after check of an available hypothesis, and in the signals selected with the demodulator in absence of sequence of the checked signals;
each universal tracking channel 600 containing the multiplexer 601 to chose one of the input signals, the Doppler heterodyne comprising the carrier generator 602 and the multiplier 603, correlators 620, the demodulator 604, the programmable code generator 608, the RAM table code sequence generator 609, programmable time delay line PTD 630 and two related multiplexers 605 and 610, where
the demodulator 604 executed with a possibility of removing of additional subcarrier signal modulation;
the RAM table code sequence generator 609 executed with a possibility of use of arbitrary nonrecursive code sequences;
the programmable code generator 608 executed with a possibility of the recursive code generation on the basis of the preset polynomial;
the first multiplexer 610 executed with a possibility of switching between the table code generator 609 and the programmable code generator 608 on the basis of polynomials;
the second multiplexer 605 executed with a possibility of signal choice from input or output of the demodulator 604 for further processing;
each of L correlators 620 executed with a possibility of use of the code sequence delayed concerning other correlators;
direct data reading channels 900 executed with a possibility of implementation of preliminary processing according to the given settings and with a possibility of accumulation of the processed data;
in case of use of the fast Fourier transform unit 305 for fast signal search of the navigation satellite, the storage device 304 is executed with a recording capability via the exchange unit 308 of received data after preliminary processing, and the fast Fourier transform unit 305 is executed with a possibility of processing under control of the central processor 303 of data from the storage device 304, at the same time use of the central processor 303 for receiving the necessary estimates of frequency offset and time delay of the received signal.
the collector 700 executed with a possibility of reading according to the given settings of results of operation of the universal tracking channel 600, with a possibility of formation of data packets, with a possibility of conversion data packets to the required machine-readable view and with a possibility of their output at the request of CPU 303;

The preferred implementation of the device includes the input interface unit 400 and the external interface unit 307, executed with a possibility of data interchange with external devices, at the same time the input interface unit 400 executed with a possibility of conversion of an input signal to the machine-readable data format used in the device, and the external interface unit 307 executed with a possibility of implementation of inverse transformation.

The preferred implementation of the device includes the radio-frequency path 302 executed with a possibility of separation of the signals containing the navigation satellite signals selected from a set of signals including GLONASS signal of the ranges L1 and L2, GPS signal of L1 range, Galileo signal of L1 range, BeiDou signal of B2 range from the output signal of the receiving radio-frequency path.

The preferred implementation of the device includes the universal tracking channels 600 executed with a possibility of keeping synchronization with the detected navigation satellite signal, with a possibility of separation of the navigation satellite useful signal, and also with a possibility of an additional search of the navigation satellite signal in bad receiving environment.

The preferred implementation of the device includes the fast search units 800 executed in the form of the coordinated filter executed in the form of clocked shift register of the navigation satellite signal and the programmable code register with a possibility of coherent and/or noncoherent detection of correlation by comparing, at each clock period, separate code bits of the code register and the appropriate separate code bits of the shift register, and also with a possibility of accumulation of coherent and/or noncoherent estimates of correlation at duration of at least two epochs.

The preferred implementation of the device includes the hypothesis generator executed in the form of the reference code sequence generator executed with a possibility of formation of a signal with arbitrary delay and frequency offset.

The preferred implementation of the device includes the correlative processing unit 300 executed with a possibility of inputting the signals subject to processing from three radio-frequency paths of analog receiving and amplifying part of the navigation receiver, at the same time each of three input signals is complex; material and imaginary components of signals can be single-bit or two-bit in the sign amplitude format.

The preferred implementation of the device includes the correlator 620 executed with a possibility of multiplication of the received signal with reference code sequence and accumulation of the received convolution at the interval of one epoch in the first integrator 622 with the subsequent accumulation of these estimates in the second integrator 623 in the interval of at least two epochs.

The preferred implementation of the device includes
the signal simulator 500 containing the signal generator 501, a modulator 502, a code 503 generator, a RAM table code sequence generator 504, a multiplexer 505 to choose one of input signals, a Doppler heterodyne comprising a carrier generator 507 and a multiplier 506, a noise simulator comprising a noise generator 512, a noise value register 511, a multiplier 510, a signal and noise combiner 508 and a output signal limiter 509, also
the signal generator 501 executed in the form of the meander binary sequence generator;
the RAM table code sequence generator 504 executed with a possibility of use of arbitrary replicas of a signal or nonrecursive code sequences;
the programmable code generator 503 executed with a possibility of the recursive code generation on the basis of the given polynomial;
the multiplexer 505 executed with a possibility of switching between the table code generator 504 and the programmable code generator 503 on the basis of polynomials.

For implementation of the applied invention, the following hardware opportunities are realized in the device for simultaneous signal receiving of different satellite navigation systems:
search of Galileo signals by the fast Fourier transform unit;
accelerated search of GLONASS, GPS and BeiDou/Compass new satellites in the preset frequency range and time steps by the fast search units with a possibility of receiving coherent and noncoherent estimates of a signal of arbitrary duration in the interval of several epochs;
additional signal search for already found satellites of four navigation systems in the course of tracking directly in the tracking channels, and also the signal search by a combination of these units;
receiving of signals of all types by the universal tracking channels allowing to receive both subcarrier modulated and non-modulated signals, at the same time the expanding code sequence can be set both as a polynomial, and as a table;
use of a collector for acceleration of data exchange between the navigation processor and the tracking channels by preliminary processing and formation of data packets with a preset structure.

Satisfaction of requirements of all navigation standards and receiving environment is reached due to flexibly switched structure of the units according to the given settings, and enhanced accuracy and speed of positioning due to use of the greatest possible number of satellites of all navigation standards meeting the set selection criteria.

### BRIEF DESCRIPTION OF THE DRAWINGS

For better understanding of the applied invention, its detailed description with the appropriate figures is provided below.

FIG. 1. Block diagram of the satellite navigation receiver implemented according to the prototype.

FIG. 2. Block diagram of the fast search device implemented according to the prototype.

FIG. 3. Block diagram of the device for simultaneous signal receiving of different satellite navigation systems implemented according to the invention.

FIG. 4. Block diagram of the input interface unit implemented according to the invention.

FIG. 5. Block diagram of the signal simulator intended for check of operability of the device for simultaneous signal receiving of different satellite navigation systems, implemented according to the invention.

FIG. 6. Block diagram of the universal tracking channel implemented according to the invention.

FIG. 7. Block diagram of the collector implemented according to the invention.

FIG. 8. Block diagram of the of hypothesis check unit implemented according to the invention.

FIG. 9. Block diagram of the direct data reading channel intended for implementation of program search methods implemented according to the invention.

FIG. 10. Block diagram of the programmable delay line implemented according to the invention.

### DETAILED DESCRIPTION OF THE INVENTION

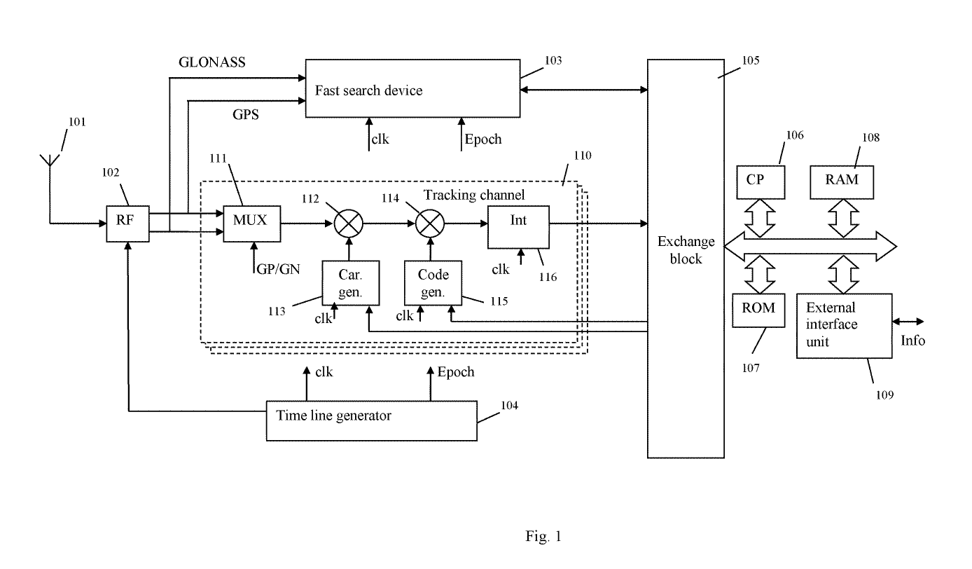

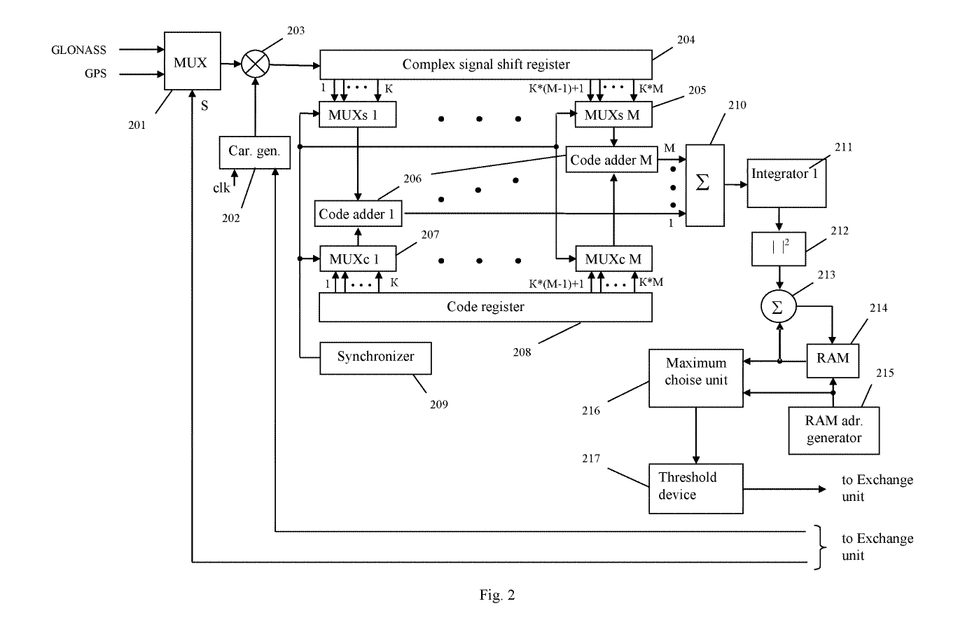

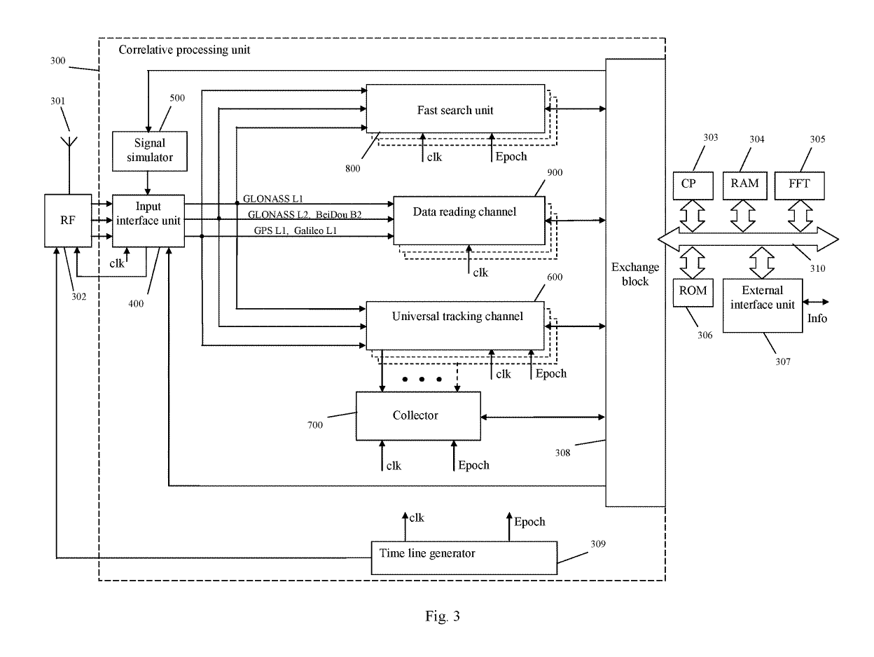

We will consider the applied invention implementation provided in FIGS. 1-10 in more detail.

The solution fast search problem for all navigation systems, except Galileo, and the subsequent tracking all found satellites is implemented by the correlative processing unit (CPU) 300. CPU functionally represents the multi-channel correlator (MCC) with different types of channels and consists of several fast search units (UFS) 800, a group of the universal tracking channels (UFUC) 600, the collector 700, the input interface unit (UII) 400, the exchange unit (UE) 308, the signal simulator (SS) 500, and the time line generator (TLG) 309. For fast search of Galileo signals a set of the direct data reading channels (CDDR) 900 which are also a CPU part, the central processor (CP) 303 and the unit of the fast Fourier transform (FFT) 305 are used. For descriptive reasons the set of identical parallel channels and their interblock connections are shown in the figures by an example of one unit of this kind, and the signals transmitted from one unit to another are the multibit buses including all signals transmitted between these units.

In the operating mode the CPU functions in interaction and under control of the navigation central processor (CP) 303, the data and settings necessary for operation of CPU and the CP are stored in the storage devices 306 and 304. The CPU by means of the exchange unit 308 reads out the correlative processing results from the channels and writes these controls of channels in the appropriate channel registers. Combining of all units in the uniform functional finished device is executed by the data bus 310 and the exchange unit 308 providing the necessary data and controlling commands interchange. For the data interchange with the external devices, the input interface unit 400 and the external interface unit 307 are used. The clock syncs, necessary for the synchronous multi-channel correlative processing, are created in the time line generator 309.

The input interface unit 400 is intended for organization of interaction between the CPU 300 and the radio-frequency path (RFP) 302, and also for connection of correlative channel inputs (units 600, 800 and 900) to the signal simulator 500 output in the self-test mode. The radio-frequency path provides useful signal separation in three frequency ranges: L1 GPS/Galileo (CA), L1 GLONASS (CT) and L2 GLONASS/B2 BeiDou(CT).

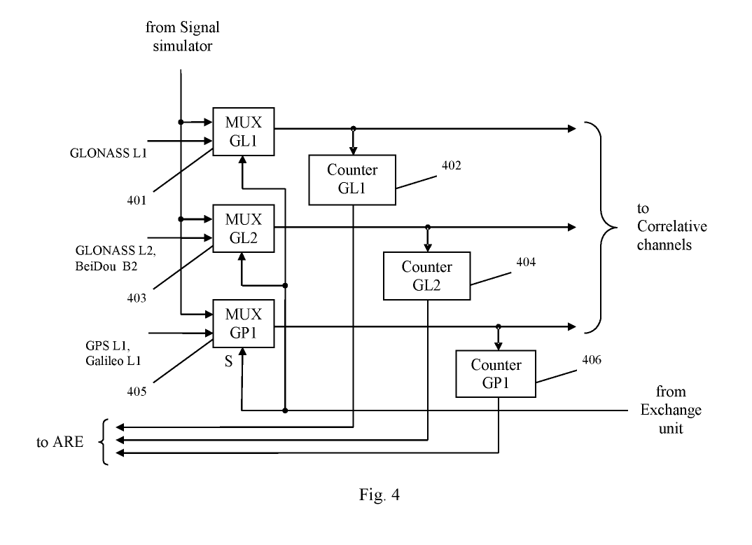

Apparently from the FIG. 4 showing the input interface unit 400, in addition to three multiplexers 401, 403 and 405 (“MUX GL1”, “MUX GL2” and “MUX GP1”, respectively) switching CPU 300 input to the self-test mode and back to the operating mode, the input signal level counters 402, 404 and 406 are realized (respectively, “GL1 Counter”, “GL2 Counter” and “GP1 Counter” in the figure). The counters are intended for count of the average level of the signals arriving from the radio-frequency path. For assessment of the level of signals in each subchannel in a given interval, a number of single statuses of each input signal bit are accumulated. At the end of accumulation the result is transferred to the device output and can be used for leveling adjustment of the input ARE. For self-test, a GPS or Galileo signal (unit 405), GLONASS (units 401 and 403) signal or BeiDou (unit 403) signal are applied to the appropriate inputs of multiplexers.

The simulator 500 is intended for signal generation which with sufficient reliability repeats a signal of one of GPS, GLONASS, Galileo or BeiDou satellites. This signal can be used instead of an input signal from the radio part 302 in the receiver that allows to check operation of the modules.

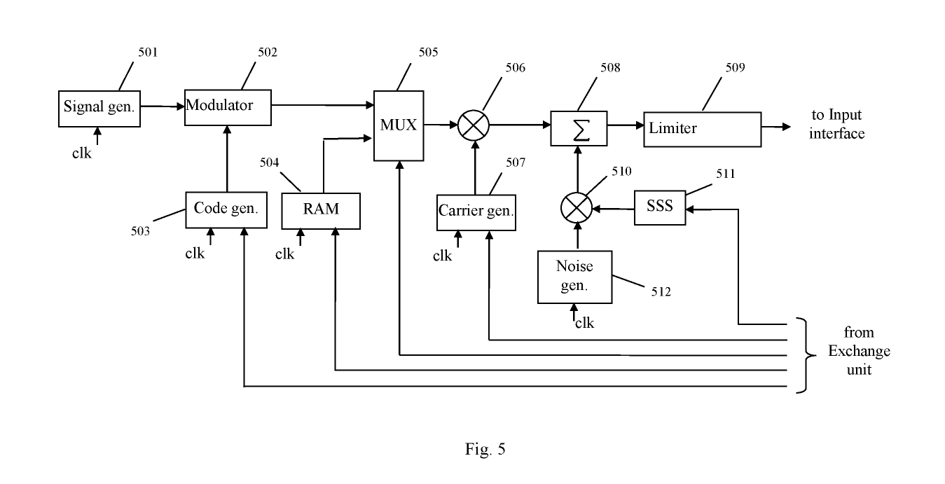

The simulator shown in FIG. 5 includes the signal generator 501, the code generator (pseudorandom sequence—pseudo-random sequence) 503, the modulator 502, the RAM 504, the multiplexer 505, the carrier generator (the Doppler heterodyne) 507, the multiplier 506, the noise generator 512 with the scaling multiplier as a part of the multiplier 510, and the scaling coefficient setting register (SSS) 511, and also the adder 508 and the signal level limiter 509.

The code generator 503 sets the reference pseudo-random sequence imitating a satellite pseudo-random sequence. The modulator 502 serves for superimposing of the meander with a frequency of 50 Hz generated by the signal generator to the output signal of the pseudo-random sequence generator. It imitates the information sequence bits which modulates pseudo-random sequence from the satellite. The pseudo-random sequence parameters are set externally via the exchange unit 308. The record of the necessary signal replica in the RAM 504 and its subsequent cyclic output to the signal generation is used for Galileo signal generation using the table codes. The source selection of a test signal is realized by the multiplexer 505. The use of replicas written in the RAM 504 for formation of a test signal allows to expand a possibility of self-test of the equipment in general by simulation of the most different situations which replicas can be also written in the RAM 504.

The carrier generator 507 serves for the reference signal generation, which is used for transfer of the test signal from zero frequency to the Doppler frequency. The noise level is set by the scaling coefficient SSS in the register 511. After formation of the required signal and noise compound in the adder 508, the received signal is restricted by the delimiter 509 to input bit capacity of correlative channels (600, 800 and 900) of the correlative processing unit 300.

The exchange unit 308, in the most general case, represents the microcontroller connected to the CP 303 the data bus. By transmission of the controlling signals from the CP 303 to CPU 300, the microcontroller receives control signals from the CP 303, decodes them, reads out the necessary data from the random access memory of the memory 304 and transfers them to the appropriate units. In case of data transfer from the units to the CP 303 the microcontroller executes the reverse operation, reading out the data retrieved from outputs of units and writing them in a random access memory for later processing them in the CP 303. The register unit representing two-port random access memory storing current settings of the channels and results of their operation, the access to which elements accessed from one side by all units of CPU 300 have, and from another side by the CP 303, can be another implementation option of BO 308.

The time line generator 309 creates a receiver time scale, which represents a pulse of millisecond Epoch lasting one clock period of clk and the period of 1 msec, and generates the clock signal of clk necessary for synchronization of operation of all units and modules of the receiver.

The Universal Tracking Channels (UFUC) 600 are intended for tracking a signal of GPS, Galileo, GLONASS and BeiDou satellites. A large number of the subchannels providing high accuracy of tracking make them the most effective when tracking satellites with a small signal/noise ratio or in the conditions of strong multipath distribution of a signal. Another purpose of the universal tracking channels 600 as a part of the device is an additional search of the useful signal when the satellite signal is detected by the hypothesis check unit (the fast search unit 800), but the tracking accuracy by particular criteria of the signal detection algorithm is still insufficient.

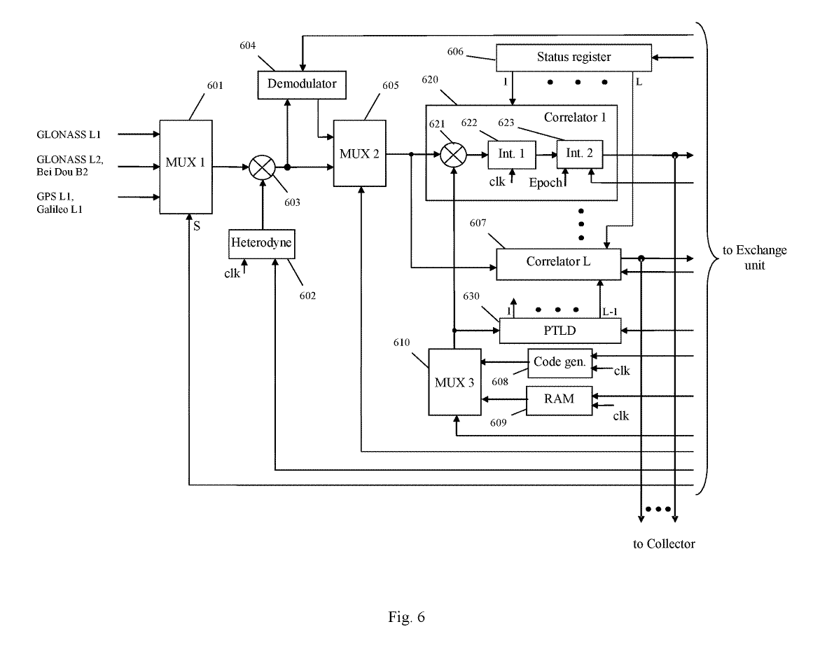

Each of the universal tracking channels 600 shown in FIG. 6 consists of L subchannels 620 with adjustable arrival time offset of the input signal, from 0 to t of digitization frequency clock periods. A choice of signals of GPS L1//Galileo L1//L1 GLONASS//GLONASS of L2//BeiDou B2 is made at the channel input by the multiplexer 601 (MUX1) controlled by the CP 303 S (Select) signal, and then the selected signal is multiplied in the multiplier 603 at the reference signal of heterodyne 602 for signal transfer from IF considering the Doppler frequency to the zero frequency. In case of subcarrier signal receiving (for example, Galileo) its additional demodulation by the demodulator 604 is necessary. The demodulator is controlled by the CP 303 via BO 308. The multiplexer 605 (MUX2) allows to select one of two signals to be further used for the expanding code decoding; while the necessary code sequence source is connected by the multiplexer 610 (MUX3): the code generator 608 or RAM 609. After convolution of the selected signal and the code the result for the preset time (from 1 to 32 epochs) is accumulated in the integrators 622 and 623. Thus, in each subchannel it is possible to receive an estimation of the received signal at a period exceeding the epoch duration. The choice of the received signal and the used expanding code is controlled by the external CP 303.

Operation of each subchannel in UFUC 600 is allowed by record of a unit in the appropriate bit of the L-bit status register 606. If the subchannel operation is disabled, then it switches to the low power mode. Thus, having disabled operation of the all L subchannels, the whole channel is disabled.

The results of the channel operation are accumulation in all used subchannels in integrators 622 (Int.1) at duration of an epoch, and integrators 623 (Int.2) at duration of several epochs which are available to reading directly via BO 308 or by the collector 700. The duration of accumulation is set by the CP 303 by BO 308 as a number from 0 to 31 which defines the number of epochs during which accumulation is made.

Generation of the reference code sequence for each subchannel is executed by the code generator 608, the RAM 609 and the programmable time delay line (PLTD) 630 with L−1 leadouts. The code generator 608 is used for generation of pseudo-random sequence which can be described in the form of polynomials; the RAM 609 is used for generation of table codes, which are able to boot in case of initial initialization of the device and to be loaded from the external ROM 306 as necessary. The number of tabs of the programmable time delay line are one unit less than the number of subchannels as the reference sequence is applied to the first channel without time delay.

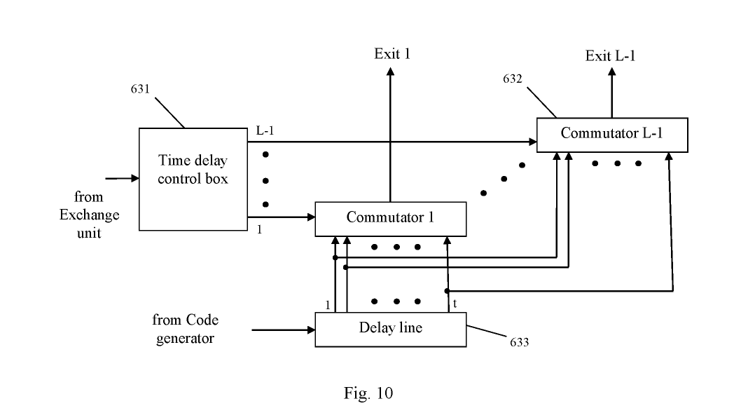

In one of options of the programmable time delay line (PLTD) shown in FIG. 10, for connection of any element of a time delay line 633 which stores the pseudo-random sequence counts to any of L−1 output PLTD 630, L−1 switches 632, each of which is connected by the inputs to elements of the time delay line are used. The switching is controlled by a time delay control box 631 receiving the controlling signal from the exchange unit 308 and decoding it in the controlling signals of the switches 632.

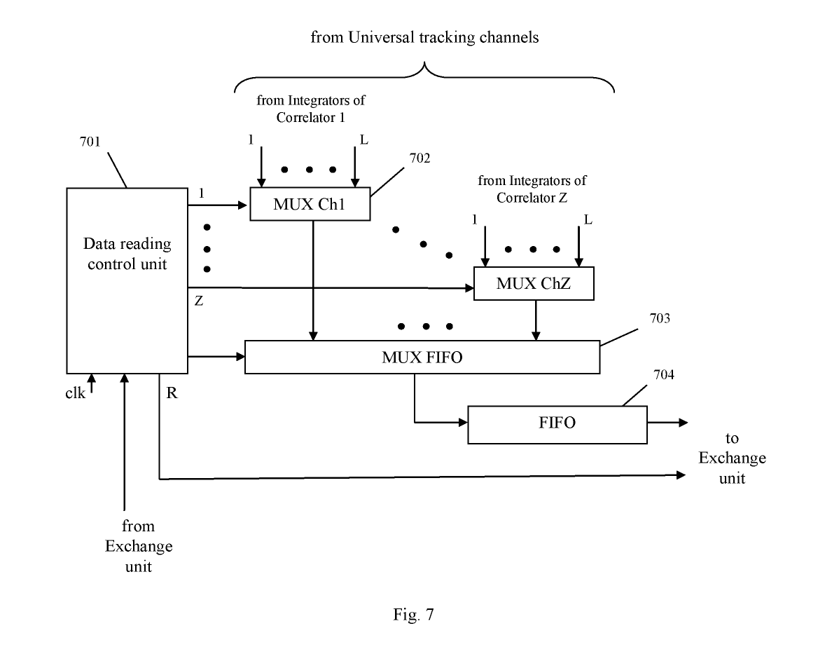

In case of information processing from several navigation systems with different structures of signals, there is a need to track the end of decoding and accumulation in the data integrators in each channel. In case of a large number of tracking channels and subchannels, the read request and the subsequent reading of separate data takes a considerable time, creating excessive load of the exchange unit 308, the CP 303 and the related data bus, reducing the device efficiency in general. For correction of this situation, the applied invention offers a data collector 700 shown in FIG. 7.

The collector contains Z multiplexers 702 (“MUX1” . . . “MUXZ”) according to the number of UFUC 600, each having L inputs according to the number of the UFUC subchannels. The outputs of these multiplexers, in turn, can be switched to a FIFO 704 output by a multiplexer 703 (“MUX FIFO”). For operation control of the collector 700, a data reading control unit (DRCU) 701 is used, which can be realized, for example, by a microcontroller. The DRCU 701 obtains all necessary information on the settings of certain tracking channels and necessary length of the created data packets from the CP 303. When necessary, the DRCU 701 allows reading of accumulation results in the channels and recording into a FIFO 704. The accumulation results of subchannels and channels are written into the FIFO 704 one after another, thus creating a data sequence which can be read by the CP 303 via the BO 308 as a continuous flow by requesting a sole address. At the same time, separate data from the channels also remain available in case of requesting the channels via the BO 308 and can be used if necessary. Upon termination of a data packet generation, DRCU 701 transfers a ready flag R to the BO 308.

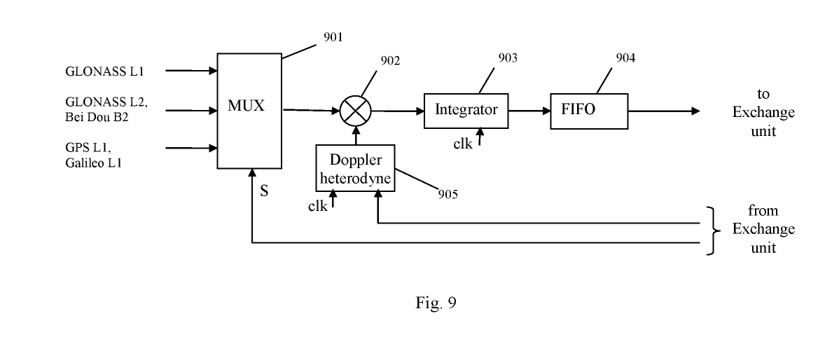

The direct data reading channel (DDRC) 900 shown in FIG. 9 is also intended for implementation of the program search methods using the FFT 305 (in our case for Galileo signal receiving), or other program search and tracking algorithms. It includes an input multiplexer 901, the heterodyne for signal transfer from IF and compensation of the Doppler shift (units 905 and 902), an integrator 903 with the programmable accumulation duration, and a buffer data the FIFO 904.

Originally, the input data are applied to the multiplexer 901, which depending on settings, selects one of the inputs. Then the data are transferred from IF to zero frequency by multiplication by the Doppler heterodyne 905 signal in the multiplier 902. The multiplication product is accumulated in the integrator 903, the accumulation results remain in the FIFO data buffer 904 of 2048 samples in depth from where the CP 303 is able to read them via BO 308 and the data bus.

For search of the Galileo signal time delay, the data from the FIFO 904 are saved in the memory 304, further, by program interpolation and/or decimation, two samplings with equal frequency sampling rate are created in the CP 303, one of the received signal, and another of the reference sequence. By direct Fourier transform of both samplings, their bit-by-bit multiplication and inverse Fourier transformation, a decisions sampling which maximum specifies the signal time delay is created. For the frequency shift search this operation is executed repeatedly with a given step for all possible frequency positions. Moreover, depending on the CP 303 algorithm implementation features, either a program frequency transfer of already received sampling, or correction of the heterodyne reference signal in DDRC 900 before data accumulation in its FIFO 904 can be used.

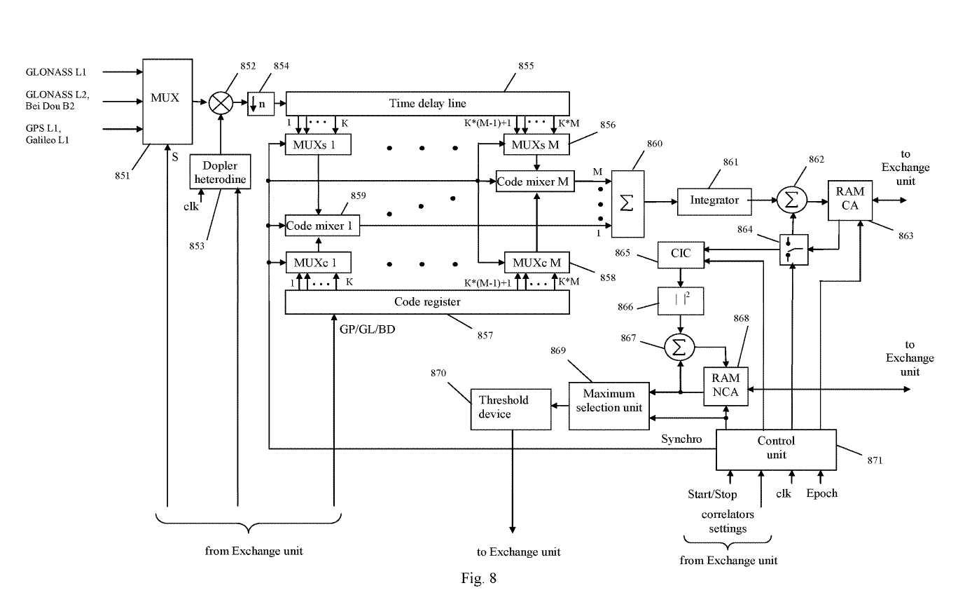

The fast search units 800 are intended for search of satellite signals in the ranges of GPS L1/GLONASS L1/GLONASS L2/BeiDou B2. The search is made by all hypotheses of the pseudo-random sequence time delay, in case of the given pseudo-random sequence, and the Doppler frequency, thus this unit actually represents the hypothesis check unit of preset signal parameters, and the pseudo-random sequence generator (the RAM for table codes) and the Doppler heterodyne are the hypothesis generator, and the correlative accumulation result is an assessment of credibility of this hypothesis. The search result is an amplitude of the maximum received correlative peak and its position concerning the epoch signal in chips and chip particles with half-chip sample for GPS and GLONASS and one chip sample for BeiDou. The implementation of BBP 800 is shown in FIG. 8, and the operation is described below.

BBP 800 calculates the mutually correlative function (MCF) of the input signal and pseudo-random sequence in 2046 (GPS)/2044 (GLONASS)/2046 (BeiDou) pseudo-random sequence positions, concerning the signal. The choice of the reference pseudo-random sequence used for the search is realized by application of the “GP/GL/BD” control signal to switch the code register, which stores the reference sequences in the GPS, GLONASS or BeiDou search mode. The correlation values are coherently accumulated within 1-16 epochs, and then the coherent accumulation result is considered in the noncoherent accumulation from 1 to 16 times.

BBP 800 can be in a standby mode and in a search mode. In the standby mode the arriving data are not processed, and the last search results are stored in CA 863 RAM (coherent accumulation RAM), and RAM NCA 868 (noncoherent accumulation RAM) of the unit, and they are available to the CP 303 via the exchange unit 308. At a CP 303 command, the fast search unit 800 is either switched into the search mode or stops. It is made by application of the Start/Stop signal to an appropriate control unit 871 input.

The control unit 871 controls the general operations of the device and creates all signals necessary for operation. The unit produces the synchronizing signal (Synchro) necessary for operation of code multiplexers 858 (“MUXc 1”-“MUXc M”), and signal multiplexers 856 (“MUXs 1”-“MUXs M”), and also code mixers 859 (“Code.mix.1”-“Code.mix.M”). Interruption in supply of this signal stops operation of the specified units. In addition, the control unit 871 controls settings of coherent and noncoherent accumulation in RAM 863 and 868, switching of a data output key 864 of the RAM CA 863 in the CIC-filter 865, change of the CIC filter order, and data addressing in the RAM 863 and 868 in case of record/reading.

In the search mode the unit input signals from the antenna 301 and the radio-frequency path 302 via the input interface unit 400 arrive to a multiplexer 851 (“MUX”) where from one input signal is selected three input signals for processing. Then the signal is multiplied (in a multiplier 852) at a Doppler heterodyne (“Car.Gen.”) 853 reference signal which frequency is set by the CP 303. The multiplication product is decimated n-fold by a decimator 854 (if necessary, before achievement of the 1^{st} sample per the pseudo-random sequence chip for BeiDou, 2 samples per the pseudo-random sequence chip for GPS, and 4 samples per the chip for GLONASS), and saved in a delay line 855. Thus 2046 (GPS)/2044 (GLONASS)/2046 (BeiDou) results are saved, and BBP begins to calculate MCF of the saved signal samples with pseudo-random sequence which is stored in the memory (a code register 857). A combination of units 860 and 861 is used to generate a single sample MCF. The calculated complex MCF is accumulated by an adder 862 in a coherent accumulation buffer (RAM CA 863) at the address corresponding to the analyzed position of the signal in respect to the pseudo-random sequence (at the initial moment at the address 0). In case of the first coherent accumulation a number is loaded to the RAM CA (coherent accumulation RAM), and in other cases it is accumulated.

After that the sampling stored in the time delay line 855 is cyclically shifted, MCF is calculated again and accumulated in the RAM CA 863 at the next address. It is repeated 2046/2044 times to provide MCF for all mutual data positions concerning the pseudo-random sequence. To obtain the coherent accumulation for several epochs, this computation process is repeated several times, and the results of the subsequent complex MCF is added to the previous one in the RAM CA 863. The number of repetitions is set by the CP 303.

The created coherent evaluations of all reference code shift positions are applied to the FIR filter input via a key 864 controlled by the control unit 871 with single coefficients of 865 (“CIC”). When the signal is processed at the frequency greater than chip, the use of filtering allows to collect the power of several chips in one and thus to maximize the true correlative peak. The filter order changes depending on the settings transferred from the control unit 871 (1 for BeiDou, 2 for GPS, 4 for GLONASS).

Upon accumulation of a preset number of coherent accumulations and filtering, the fast search unit makes noncoherent accumulation calculating power values for each position of the coherent accumulation (unit 866), and accumulates them in the RAM NCA 868. At the first appeal to the RAM NCA 868 the data are loaded in the RAM, and in other cases the accumulation is performed.

All cycle provided above is repeated so many times, so many noncoherent accumulations are set by the CP 303 signal. The maximum is selected from the noncoherent accumulation results (from a Maximum selection unit 869) and its position is stored; if several maxima are available, the first one is stored. Besides, the NCA results throughout the BBP operation are compares to the early search break threshold (a threshold device 870). If this threshold is exceeded by any accumulation, the search is stopped, and the accumulation position is stored in the maximum choice unit 369. Upon termination of all operations the machine is switched in a standby mode. The given procedure of search is applied both to GPS, and GLONASS.

The applied invention allows to receive signals both of the long existing GPS and GLONASS systems, and new actively developed navigation systems, for example, such Galileo and BeiDou (Compass). Use of a large number of satellites belonging to the orbiting groups of different navigation standards allows not only to increase speed and accuracy of the of the navigation decision due to selection of satellite signals with the best receiving environment, but also gives an ability to maintain the navigation at the high level in cases when for technical, political, commercial or other reasons one of orbiting groups of satellites is unavailable. Besides, increase in accuracy and speed of search of new satellites is reached at the expense of coherent-noncoherent accumulation in BBP 800. The use of UFUC 600 increases tracking possibilities of a multipath signal and allows the exact additional search of signals directly in the course of operation of the receiver.

Though the invention implementation described above is explained as an illustrative of the present invention, it is quite clear that different modifications, adding and changeovers within the scope and the sense of the present invention revealed in the claims are possible.

1. A device for simultaneous signal receiving of different satellite navigation systems containing an antenna connected to a receiving radio-frequency path input connected to a correlative processing unit (CPU), and also to a navigation central processor (CP), a random access memory, a read-only memory (ROM), and a fast Fourier transform unit (FFT) which are interconnected and connected to a correlative processing unit (CPU) via a data bus and interacting with another units of the device via an exchange unit (UE) which is a part of the correlative processing unit (CPU), which also contains a multi-channel correlator (MCC) with different types of channels comprising Q fast search units (UFS), Z universal tracking channels (UFUC), N direct data reading channels, a collector, an input interface unit (UII), the exchange unit (UE), a signal simulator (SS), and a time line generator (TLG), and the exchange unit connected to the fast search units (UFS), to the universal tracking channels (UFUC), to the direct data reading channels, to the collector, to the input interface unit (UII), to the exchange unit (UE), to the signal simulator (SS), and to the time line generator (TLG) which is connected to the radio-frequency path which is connected to the input interface unit which is connected to the signal simulator, and the collector is connected to the universal tracking channels, and the fast search units, the universal tracking channels, the direct data reading channels and the input interface unit are interconnected, and
the receiving radio-frequency path containing a demodulator able to separate the signals containing the navigation satellite signals in the preset range of carrier frequencies;
the external interface unit able to make information exchange with the end users;
the input interface unit able to organize interaction between the correlative processing unit and the radio-frequency path, and also able to connect the correlative channel inputs to the signal simulator output in the self-test mode;
the input interface unit able to transmit signals to inputs of the fast search units, the universal tracking channels and the direct data reading channels able to process these signals according to the given settings of each channel;
in the operating mode the correlative processing unit is able to interact with the central processor, and the central processor is able to read the correlative processing results by the exchange unit from the channels, and able to record the channel control data to the appropriate channel registers;
the time line generator able to generate the device time scale, epoch signals, duration of intervals between epochs equal to duration of an epoch of the satellite navigation system, and also able to generate a clock signal necessary for synchronization of operation of all units and modules of the device;
fast search units able to check availability of the navigation satellite signal in the received radio-frequency signal, able to determine the time shift of the navigation satellite signal concerning the epoch signal, and also able to determine Doppler frequency shift caused by mutual relocation of the satellite and the device, and the fast search units are able to detect availability and position concerning the epoch signals, sequence of the checked signals in the signals selected by the demodulator at least for two epochs;
each fast search unit containing a received signal hypothesis generator which is represented by the machine-readable data providing generation of sequence of the checked signals corresponding to the signal sequence of navigation satellites and set according to the settings transmitted from the central processor via the exchange unit;
each fast search unit connected to the bus of data, addresses and control of the device that provides transmission of a checked hypothesis together with the data on the specified position to one of the universal tracking channels, and also continuous determination and adjustment of the epoch signal hypothesis, and thus the optimum separation of the received signal, besides, the fast search unit is executed able to request and/or install via the bus of data, addresses and control a new hypothesis after check of the hypothesis with present or absent sequence of checked signals in the signals selected by the demodulator;
each universal tracking channel containing a multiplexer to choose one of input signals, a Doppler heterodyne comprising a carrier generator and a multiplier, L correlators, a demodulator, a programmable code generator, a RAM table code sequence generator, a programmable time delay line PLTD and two related multiplexers, and
the demodulator able to remove additional modulation of a subcarrier signal;
the RAM table code sequence generator able to use arbitrary nonrecursive code sequences;
the programmable code generator able to generate a recursive code on the basis of the given polynomial;
the first multiplexer able to switch between the table code generator and the programmable code generator on the basis of polynomials
the second multiplexer able to choose a signal from the demodulator input or output for further processing;
each of L correlators able to use of the code sequence delayed concerning other correlators;
direct data reading channels able to implement preliminary processing according to the given settings and able to accumulate the processed data;
the collector able to read according to the given settings the operation results of the universal tracking channel, able to generate data packets, able to convert the data packets to the required machine-readable form and able to output the data packets at the CP 303 request;
in case of use of the fast Fourier transform unit for fast search of a signal of the navigation satellite, the storage device is able to record the received data after preliminary processing via the exchange unit, and the fast Fourier transform unit is able to process the storage device data under control of the central processor, at the same time using the central processor for receiving the necessary estimates of frequency offset and time delay of the received signal.

2. The device of claim 1 distinguished by the input interface unit and the external interface unit executable to interchange the data with external devices, at the same time the input interface unit is able to convert the input signal to machine-readable data format used in the device, and the external interface unit is able to implement inverse transformation.

3. The device of claim 1 distinguished by the radio-frequency path executable to separate the signals containing signals of the navigation satellites selected from a set of signals including L1 and L2 range GLONASS signal, L1 range GPS signal, L1 range Galileo signal, B2 range BeiDou signal from the output signal of the receiving radio-frequency path.

4. The device of claim 1 distinguished by the universal tracking channels executable to keep synchronization with the detected signal of the navigation satellite, able to separate the useful signal of the navigation satellite, and also able to carry out an additional search of the navigation satellite signal in bad receiving environment.

5. The device of claim 1 distinguished by the fast search units executed in the form of the matched filter executed in the form of a clocked shift register of the navigation satellites signal, and a programmable code register able to carry out coherent and/or noncoherent detection of correlation by comparing, at each clock period, separate code bits of the code register, and the appropriate separate code bits of the shift register, and also able to accumulate the coherent and/or noncoherent correlation estimates during at least two epochs.

6. The device of claim 1 distinguished by the hypothesis generator executed in the form of the reference code sequence generator able to generate a signal with arbitrary delay and frequency offset.

7. The device of claim 1 distinguished by the correlative processing unit executable to receive to the input the signals to be processed from three radio-frequency paths of the analog receiving and amplifying part of the navigation receiver, at the same time each of three input signals is a complex one, and material and imaginary components of the signals can be single-bit or two-bit in the sign amplitude format.

8. The device of claim 1 distinguished by the correlator executable to multiplicate the received signal with the reference code sequence and accumulate the received convolution within one epoch interval in a first integrator with the subsequent accumulation of these estimates in a second integrator within an interval of at least two epochs.

9. The device of claim 1 distinguished by:
the signal simulator containing a signal generator, a modulator, a code generator, a RAM table code sequence generator, an input signal choice multiplexer, a Doppler heterodyne comprising a carrier generator and a multiplier, a noise simulator comprising a noise generator, a noise value register, a multiplier, a signal and noise combiner, and an output signal limiter, where
the signal generator executed in the meander form of a binary sequence generator;
the RAM table code sequence generator executed with a possibility of use of arbitrary signal replicas or nonrecursive code sequences;
the programmable code generator executed with a possibility of recursive code generation on the given polynomial basis;
the multiplexer executed with a possibility of switching between the table code generator and the programmable code generator on the polynomial basis.
